(19) United States
(12) Patent Application Publication
(10) Pub. No.: US 2003/0137990 A1
(43) Pub. Date: Jul. 24, 2003

(54) Apparatus for extraneous information removal and end mark insertion of an N-byte wide data stream of unknown length

(76) Inventors: Donald E. Rush, El Dorado Hills, CA (US); Karthi R. Vadivelu, Fair Oaks, CA (US)

Correspondence Address: Saina S. Shamilov, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/056,532

(22) Filed: Jan. 23, 2002

(51) Int. Cl. H04J 15/00

(52) U.S. Cl. 370/464

(57) ABSTRACT

An apparatus and method for removing extraneous information are disclosed. The apparatus may comprise a receiver to receive bytes of a data packet. The receiver may transmit relevant bytes of the data packet while receiving the bytes. The receiver may identify irrelevant bytes of the data packet while receiving the bytes. The apparatus may also comprise a data customer to receive only the relevant bytes of the data packet.

### FIELD OF THE INVENTION

The present invention relates to transferring data via a data bus. Particularly, the present invention relates to transferring a data stream of unknown length to a data receiver via a protocol receiver by removing information that is irrelevant to a data receiver.

### BACKGROUND OF THE INVENTION

In order to communicate with different computer devices, a device usually contains a protocol receiver capable of receiving data formatted according to a particular standard, for example the Universal Serial Bus (USB) standard.

As one of its functions the protocol receiver, as part of a USB host controller, has an ability to receive data in a byte-wide stream from a serial transceiver. The transceiver delivers bytes to the protocol receiver one at a time, until a final byte is delivered containing an end of a data packet indication.

Upon receiving data, the protocol receiver removes information that is not considered relevant by the next upstream receiver. A USB packet contains a sequence of bits representing an end of packet indication.

Due to the fact that the protocol receiver, as part of the USB host controller, has a limited amount of storage space relative to the next upstream receiver, the protocol receiver must transmit data to the next upstream receiver as it is being received.

A data packet from a USB device may be as large as 1024 bytes, whereas a practical amount of storage for the protocol receiver is on the order of a few bytes. Further, the transmitted data packets may contain error correction code bytes. For examkple, in the case of USB technology, a data packet contains the error correction code in the last two bytes of the data packet. In addition, the USB protocol allows for a data packet to be of unknown length within the range of 0 to 1024 bytes. Thus, the protocol receiver upon receiving data, is not capable of determining which bytes of the data packet are irrelevant to the next upstream receiver prior to receiving the end of packet indication. Hence, by the time the protocol receiver receives the end of the packet indication, the irrelevant bytes inadvertently may have been forwarded to the next upstream receiver.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a basic system architecture;

FIG. 2 illustrates one embodiment of a data packet;

FIG. 3 illustrates one embodiment of a controller;

FIG. 4 illustrates one embodiment of input and output signals of a controller;

FIG. 5 is a timing diagram illustrating one embodiment of a data reception by a controller;

FIG. 6 illustrates one embodiment of a state machine of a protocol receiver;

FIG. 7 illustrates one embodiment of a packet processing circuit; and

FIG. 8 is a timing diagram illustrating one embodiment of input and output signals of a controller and a packet processing circuit.

### DETAILED DESCRIPTION

Although the present invention is described below by way of various embodiments that include specific structures and methods, embodiments that include alternative structures and methods may be employed without departing from the principles of the invention described herein.

In general, embodiments described below feature a design for transferring data to a data receiver via a protocol receiver. One embodiment features a First In First Out (FIFO) circuit design for transferring only relevant data to the data receiver.

In one embodiment, the protocol receiver constitutes part of a Universal Serial Bus (USB) host controller.

USB-related Technology

As indicated above, in one embodiment the protocol receiver is part of the USB host controller. Accordingly, some introduction to USB-related technology is helpful in understanding one embodiment of the invention. USB is a bus, which is a collection of wires capable of transmitting data from a source to a destination. When used in reference to personal computers, the term ‘bus’ usually refers to internal bus that connects internal computer components to the Central Processing Unit (CPU) and main memory. A bus that connects a computer to peripheral devices is an external bus.

Buses consist of an address bus and a data bus. The data bus transfers actual data whereas the address bus transfers information about the data destination. The size of the bus, known as bus width, determines the amount of data that can be transferred at one time. For example, a 16-bit bus can transmit 16 bits of data at a time, a 32-bit bus can transmit 32 bits of data, etc.

USB is an external bus that utilizes a four-wire cable interface. Two of the four wires are used in a differential mode for both transmitting and receiving data, while the remaining two wires are power and ground wires. The source of power to a USB device may come from a host, or a hub. The device may also be self-powered.

Another concept utilized in embodiments described herein is a sideband. In electronic signal transmission, a sideband may refer to the portion of a modulated carrier wave that is either above or below the basic (baseband) signal. The portion above the baseband signal is the upper sideband; the portion below is the lower sideband. A sideband may also refer to an extra signal off a main signal path. Architecture

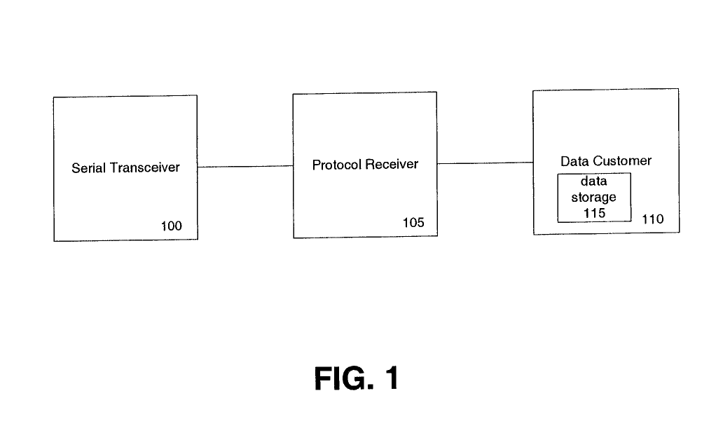

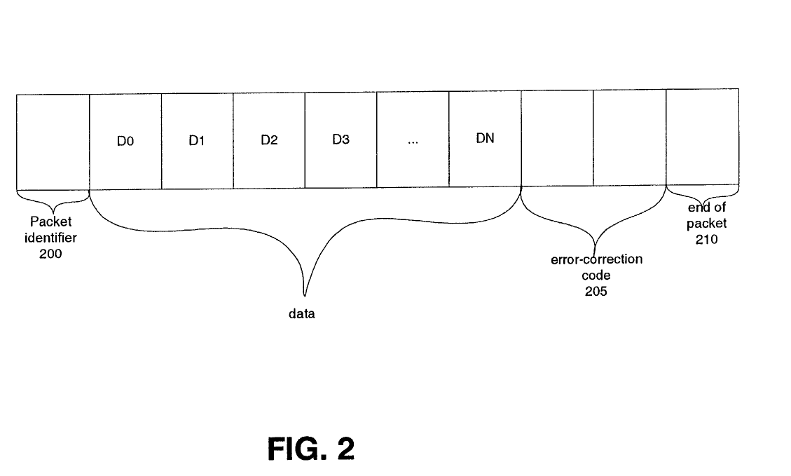

With these concepts in mind, an embodiment of a system design can be explored. In one embodiment, a serial transceiver 100 of FIG. 1 may transmit byte-wide streams of data to a data customer 110 that is received by a protocol receiver 105. FIG. 2 illustrates a data stream packet contents according to one embodiment of the invention. Each block of FIG. 2 represents a data byte. Bytes of data D0-DN, preceded by a packet identifier 200, may be followed by two bytes of error-correction code 205. It will be appreciated that any error correction method known in the art may be used. The packet may be terminated by an end of packet indication 210. In one embodiment the end of packet indication 210 may be one byte.

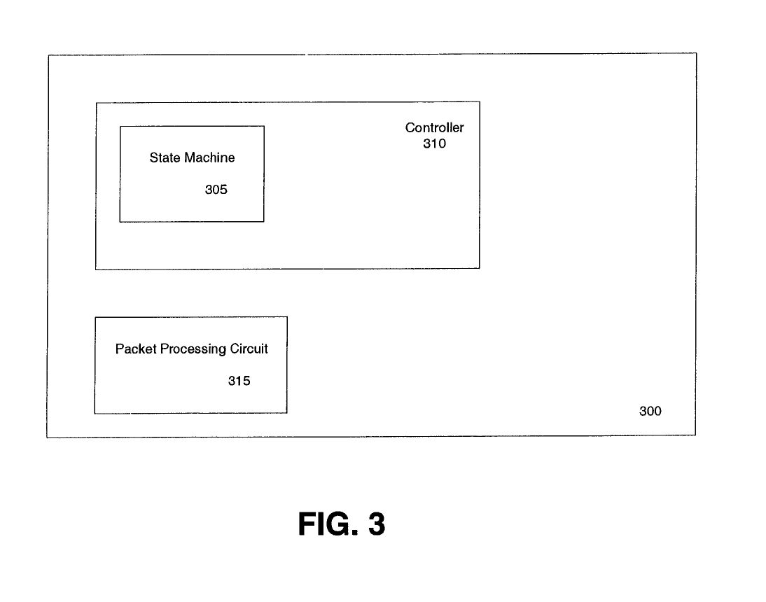

FIG. 3 illustrates components of the protocol receiver 300 according to one embodiment. A state machine 305 located in a controller 310 may receive data packets from the serial transceiver 100 of FIG. 1. An output of a packet processing circuit 315, which depends on an output of the controller 310, may be provided to the data customer 110 of FIG. 1.

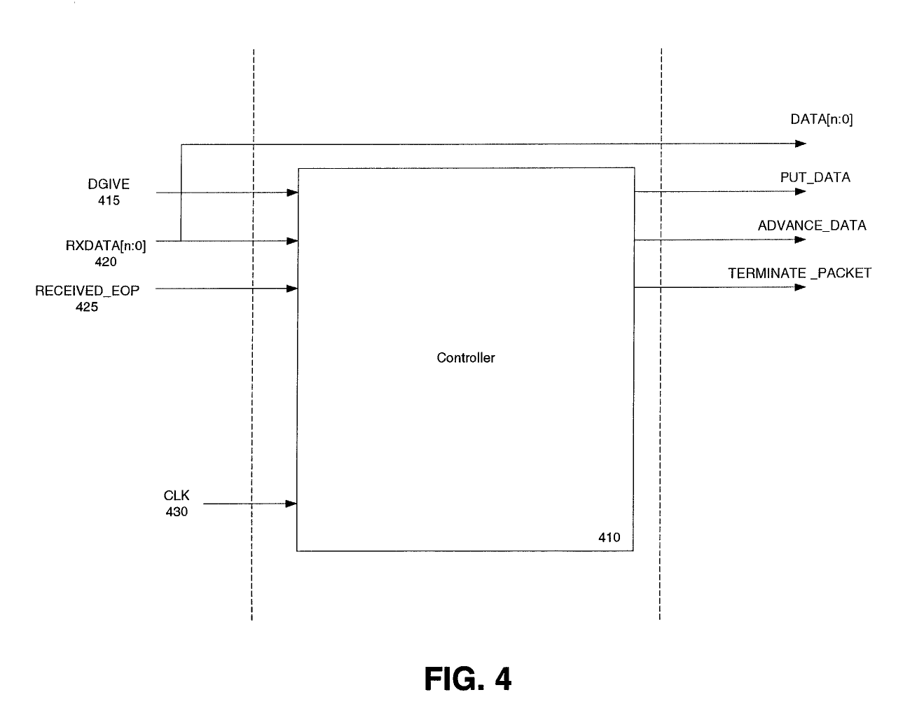

Inputs and outputs of the controller 310 are illustrated in FIG. 4 according to one embodiment. In one embodiment, the controller 310 may determine which bytes of a data packet contain error correction codes. In one embodiment the controller 410 may have the following input signals: DGIVE 415, RXDATA[n:0] 420, RECEIVED_EOP 425 and CLK 430. The DGIVE 415, a ‘data give’ signal, may contain an indication that abyte of a data packet has been received. The RXDATA[n:0] 420 signal may contain data bits of a current data packet. The RECEIVED_EOP 425 signal may contain an end of data packet indication when the last bits of the current data packet were received. In one embodiment the CLK 430 signal is a clock pin to which all signal assertions and de-assertions are synchronous.

The DGIVE 415, may be asserted when RXDATA[n:0] 420 signal or the RECEIVED_EOP 425 signal contains valid data to be sampled. In one embodiment a data packet size may range from 4 to 1028 bytes including packet identification byte, error correction code bytes and end of packet indication byte. For a given packet, a series of DGIVE 415 assertions may be received synchronous to the clock (CLK 430) input. In one embodiment, the time spacing between DGIVE assertions may be a random number of clocks.

In one embodiment, the RXDATA[n:0] 420 signal may contain data received from the serial transceiver 100 of FIG. 1 and provided by the state machine 305. In another embodiment, the RXDATA[n:0] 420 signal may contain data received directly from the serial transceiver 100 without the involvement of the state machine 305.In one embodiment n is equal to one less an RXDATA bus width. In one embodiment the bus width may be 8 bits long. In one embodiment the RECEIVED_EOP 425 signal may be asserted to indicate that the current DGIVE assertion is the last DGIVE assertion of the packet that is being received. In another embodiment the RECEIVED_EOP 425 signal is connected to the serial transceiver's 100 sideband indicating the end of a packet. In one embodiment, when the RECEIVED_EOP 425 signal is asserted, the data on the RXDATA[n:0] 420 signal is not valid at that time.

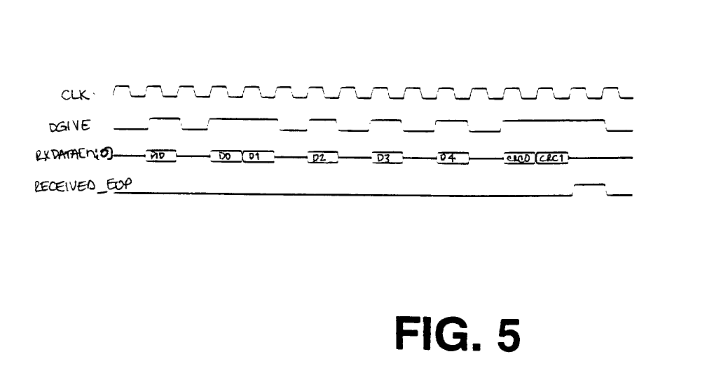

FIG. 5 illustrates an exemplary timing diagram of inputs provided to the state machine 305 and utilized by the packet processing circuit 315 along with the outputs of the controller 310. In the illustrated example, a 5-byte data packet is being received. As stated above the time spacing between assertions of DGIVE 415 may be random according to one embodiment. In FIG. 5 the spacing of DGIVE assertions after the packet identifier (PID) byte is 1 clock, 0 clock, 1 clock, 1 clock, 1 clock, 1 clock and 0 clock between the last error code correction (CRC) byte and an assertion of the RECEIVED_EOP 425 signal. It will be appreciated that the time spacings between the DGIVE assertions are not limited to the example illustrated in FIG. 5.

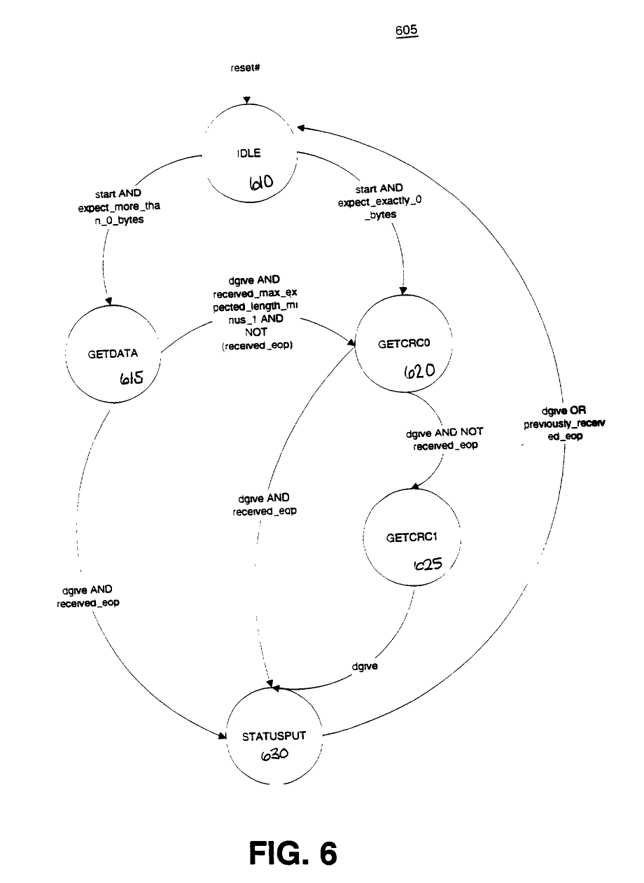

In one embodiment input signals of the packet processing circuit 315 may be derived from the state machine 305 along with outputs of the controller 310 and other sources such as a counter indicating a number of bytes received for a current data packet and located in the same functional block as the state machine 305. FIG. 6 illustrates the state machine 605 according to one embodiment. In one embodiment when a byte of a data packet arrives at a bus and a predetermined number of maximum data bytes for the packet is greater than 0, an IDLE state 610 may be changed to GETDATA state 615. If the expected number of data bytes is 0, then the state machine moves from the IDLE state 610 to the GERCRCO state 620 to receive the first byte of the error correction code. The state machine 605 remains in GETDATA state 615 until either a byte representing an end of the packet is received or the total number of bytes received, prior to the current data byte, is one less than the predetermined maximum number and the current data byte is not the end of the packet. In one embodiment the number of received data bytes is maintained by the hardware counter. If the received byte represents the end of the packet, then the state machine 605 moves to a state STATUSPUT 640, which is described below. In the other case the state machine 605 moves to GETCRCO state 620, expecting the next data byte to be the first error correction code byte. Upon receiving another data byte that does not constitute the end of the packet, the state machine 605 moves to the GETCRC1 state 625, expecting the next byte to be the second error correction code byte. From GETCRC1 state 625 the state machine 605 moves to the STATUSPUT state 630 upon assertion of another DGIVE, representing a receipt of the end of the packet byte. Once in the STATUSPUT state 630 if another DGIVE is asserted or the end of the packet byte was received, the state machine 605 moves to the IDLE state 610 waiting for the first byte of the next data packet.

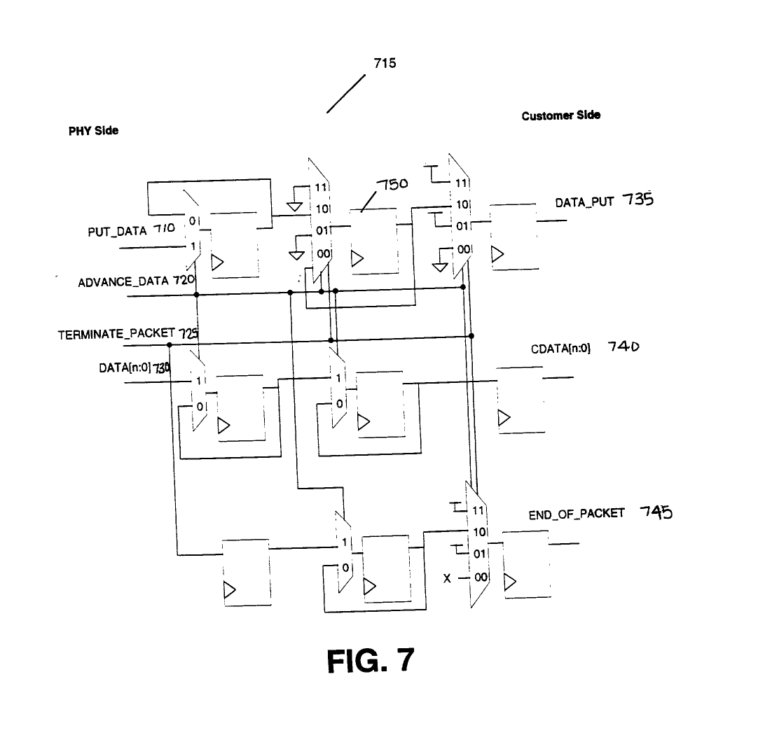

In one embodiment the output signals of the controller 410 may constitute inputs into the packet processing circuit 715 illustrated in FIG. 7. A PUT_DATA 710 signal may represent a presence of a valid data byte that may be advanced through the packet processing circuit 715 and provided to the data customer 110. In one embodiment an ADVANCE_DATA 720 signal may cause the valid byte to be advanced through the packet processing circuit 715. A DATA[n:0] 725 signal may contain data bytes of a current data packet. In one embodiment the DATA[n:0] 725 signal may not undergo any processing by the controller 410 and may be provided directly by the hardware. A TERMINATE_PACKET 725 signal may represent a receipt of an end of packet indication of a current data packet.

In one embodiment a PUT_DATA 710 signal may be asserted when the current state of the state machine 305 is equal to GETDATA or GETCRC0, the RECEIVED_EOP 425 signal is not asserted, the DGIVE 415 is asserted and the number of received data bytes of a packet is less than or equal to the predetermined maximum number of data bytes expected for this packet.

In one embodiment an ADVANCE_DATA 720 signal may be asserted when the current state of the state machine 305 is not IDLE and the DGIVE 415 is asserted. In one embodiment the ADVANCE_DATA 720 signal, when asserted, may advance data bytes through the packet processing circuit 715. In one embodiment the packet identification byte may not be pushed into the packet processing circuit 715 by being provided to the circuit when the current state of the state machine 305 is IDLE and, thus, the ADVANCE_DATA 720 signal is not asserted.

In one embodiment as DGIVE 415 is asserted, the ADVANCE_DATA 720 signal is asserted at a rate of 1 data byte per clock cycle. The ADVANCE_DATA 720 signal along with a depth of the packet processing circuit 715, defined below, ensures that no error code correction bytes are transferred to the data customer 110 of FIG. 1. In one embodiment the depth of the packet processing circuit 715 is equal to a number of storage elements in a storage elements chain, i.e. leading to the same output signal, such as DATA_PUT 735 storage elements chain or END_OF_PACKET 745 storage elements chain, both illustrated in FIG. 7. In one embodiment the transmission of data bytes to the data customer 110 of FIG. 1 may be delayed by a number of bytes equal to a one greater than the number of bytes utilized for the error correction. For example, if two bytes in a data packet represent error correction code, then the transmission of the data bytes to the data customer 110 may be delayed by three bytes. In one embodiment the transmission of the data bytes to the data customer 110 may be delayed by more than two bytes depending on the rate of the DGIVE 415 assertions. The two bytes may be stored in storage elements of the packet processing circuit 715 to ensure that upon receipt of an end of the packet indication, the two bytes representing irrelevant error correction code are stored in the circuit and, thus, may be discarded by the data customer 110 with proper identification. In one embodiment, as stated above, the packet processing circuit 715 may include a number of storage elements, as illustrated in FIG. 7. In one embodiment the storage elements may be flip flops, latches or other storage elements known in the art. The storage elements may be controlled by multiplexers present in the circuit. The following is a formula that may be used to calculate a number of storage elements of the packet processing circuit 715 required to ensure that error correction code bytes are not provided to the data customer 110:

((error_codelength+1)×data_bus_width)+((error_code_length+1)×2)

where data_bus_width is width of the data bus in bits and error_code_length is a number of bytes allocated for the error correction code in a data packet, i.e. the number of irrelevant bytes. For example, if the bus width is 1 byte and there are 2 bytes utilized for the error correction code, then the number of the storage elements that may be needed to ensure that the error correction code bytes are not transmitted to the data customer 110 is 30. In one embodiment the storage elements of the packet processing circuit 715 may be used to store a number of bytes corresponding to the number of bytes of the error correction code located in a data packet. The storage elements of a chain leading to the CDATA[n:0] 740 signal are not shown in the figures, but the presence of which is apparent to one skilled in the art.

In one embodiment a TER NATE_PACKET 725 signal may be asserted when the current state of the state machine 305 is equal to GETDATA, GETCRCO or GETCRC1, the DGIVE 415 signal is asserted and the RECEIVED_EOP 425 signal is asserted. In one embodiment the TERMINATE_PACKET 725 signal may also be asserted when the current state of the state machine 305 is STATUSPUT of FIG. 5 and the DGIVE 415 is asserted. In one embodiment, a data packet reception may be terminated if either the last byte of a data packet was received and the RECEIVED_EOP 425 signal is asserted or maximum number of data bytes was already received and another DGIVE is being asserted. In this embodiment, the state machine 305 may enter the STATUSPUT state because the predetermined maximum number of bytes allowed for a particular data packet was reached. In this embodiment, the asserted DGIVE may be treated as a DGIVE corresponding to the assertion of the RECEIVED_EOP 425 signal, and the TERMINATE_PACKET 725 signal may be asserted.

In one embodiment the outputs of the packet processing circuit 715 may include the DATA_PUT 735 signal, the CDATA[n:0] 740 signal and the END_OF_PACKET 745 signal. The DATA_PUT 735 signal, when asserted, may indicate that the data on the CDATA[n:0l 740 signal is valid and may be accepted by the data customer 110. The assertion of the signal END_OF_PACKET 745 along with the DATA_PUT 735 signal may indicate that a data byte on the CDATA[n:0] signal does not constitute valid data and the end of the current data packet has occurred. In one embodiment, the END_OF_PACKET 745 signal assertion may indicate that no more DATA_PUT 735 signal assertions will take place for the current data packet.

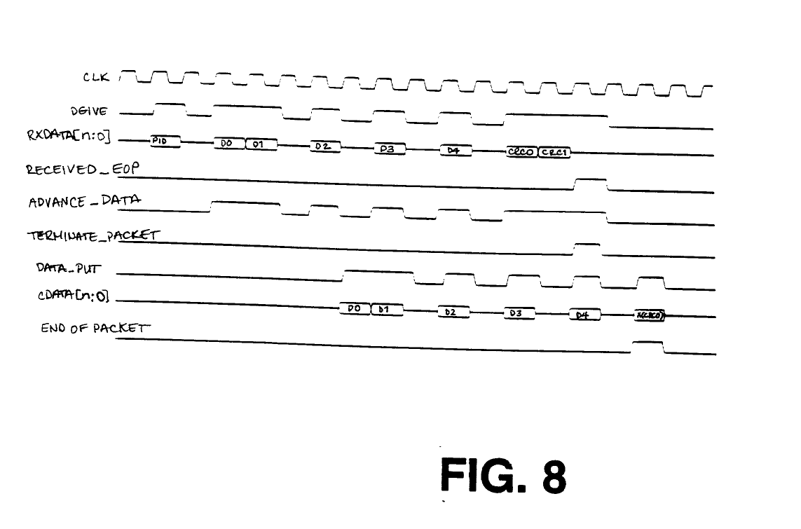

In one embodiment the data on the CDATA[n:0] 740 signal may be valid when DATA_PUT 735 signal is asserted. In one embodiment the CDATA[n:0] 740 bus may contain a first byte of the error correction code when the DATA_PUT 735 signal and the END_OF_PACKET 745 signal are asserted simultaneously. In one embodiment, the data customer 110 may consider the data of the first byte of the error correction code irrelevant when the END_OF_PACKET 745 signal is asserted. FIG. 8 illustrates a timing diagram of inputs and outputs of the controller 310 and the packet processing circuit 715.

In one embodiment when a data packet is ended and the TERMINATE_PACKET 725 signal is asserted, the packet processing circuit 715 contains error correction code bytes in its storage elements. In this embodiment the stored data bytes need not be passed to the data customer 110. For example, in FIG. 7 a multiplexer of a storage element 750 may be switched to a position 0 for the next state to ensure that a data byte stored by the storage element 750 is not pushed further into the circuit to be provided to the data customer 110 when the TERMINATE_PACKET 725 signal is asserted and the ADVANCE_DATA 725 signal is de-asserted. In one embodiment, at the same time, a multiplexer of the last storage element of the DATA_PUT 735 storage elements chain, controlling the input of data into the data customer 110, may be switched to 1 for the next state to ensure that the data customer 110 receives the last data byte.

In one embodiment the asserted TERMINATE_PACKET 725 signal and de-asserted ADVANCE_DATA 720 signal may also switch a multiplexer for the END_OF_PACKET 745 storage elements chain to ensure that on the next clock the END_OF_PACKET 745 signal is asserted. In one embodiment, the TERMINATE_PACKET 725 signal may ensure that on the next clock the END_OF_PACKET 745 signal is asserted along with the DATA_PUT 735 signal and values stored in middle storage elements of a DATA_PUT chain may be cancelled, i.e. switched to 0.

In one embodiment once a data packet is terminated or exceeded the predetermined maximum number of allowed data bytes, the state machine 305 ensures that neither PUT_DATA 710 nor ADVANCE_DATA 720 signals are asserted.

It will be appreciated that the above-described system is not limited to data packets where the irrelevant data is located at the end of a data packet. In one embodiment if the irrelevant data bytes are located not at the end of the packet, the assertion of the TERMINATE_PACKET 725 signal and de-assertion of the PUT_DATA 710 signal may ensure that irrelevant bytes are not passed to the data customer 110. In one embodiment asserting the TERMINATE_PACKET 725 signal may change values stored in a middle storage element of the DATA_PUT 735 storage elements chain to ensure that irrelevant data is not passed to the data customer 110. In this embodiment the assertions of the DATA_PUT 735 signal and the END_OF_PACKET 745 signal may be masked when the TERMINATE_PACKET 725 signal is asserted.

In addition, it will be appreciated that the above-described system for removing irrelevant data from data packets may be used whenever there is a need to remove particular data bytes prior to passing the data to the next destination point.

In the foregoing disclosure the number of irrelevant data bytes is an integer multiple of the data bus width in bytes. For example, if the data bus width is 32 bits wide, i.e. 4 bytes, the number of irrelevant data bytes may be 4, 8, 12, 16, etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. An apparatus comprising:
a receiver to receive bytes of a data packet;
the receiver to transmit relevant bytes of the data packet and to identify irrelevant bytes of the data packet while receiving the bytes of the data packet; and
a data customer to receive only the relevant bytes of the data packet.

2. The apparatus of claim 1 further comprising the receiver to transmit the relevant bytes of the data packet prior to a receipt of an end of the data packet indication.

3. The apparatus of claim 1 wherein the irrelevant bytes are error correction code bytes.

4. The apparatus of claim 2 further comprising the receiver to identify the irrelevant bytes upon a receipt of an end of the data packet indication.

5. The apparatus of claim 1 wherein the irrelevant bytes are located at an end of the data packet.

6. The apparatus of claim 1 wherein the receiver comprises a circuit to identify the irrelevant bytes.

7. The apparatus of claim 1 wherein the receiver comprises the circuit to delay transmitting of the bytes of the data packet by a predetermined number of bytes.

8. The apparatus of claim 7 wherein the predetermined number of bytes equals to a number of the irrelevant bytes.

9. A circuit comprising:
a plurality of storage elements to delay transmitting of bytes of a data packet by a predetermined number of bytes;
a first input signal to indicate presence of a valid byte of the data packet on an input data bus;
a second input signal to advance the byte through the plurality of storage elements; and
a third input signal to indicate an end of the data packet and to cancel advancement through the plurality of storage elements of bytes stored in the plurality of storage elements, the third input signal combined with the second input signal to indicate presence of an irrelevant byte on an output data bus.

10. The circuit of claim 9 further comprising:
a first output signal to indicate presence of a relevant byte of the data packet on the output data bus; and
a second output signal to indicate the end of the data packet.

11. The circuit of claim 10 wherein a storage element is a flip flop.

12. The circuit of claim 10 wherein a storage element is a latch.

13. The circuit of claim 10 wherein the predetermined number of bytes is a number of bytes representing an error correction code increased by one.

14. The circuit of claim 10 further comprising a plurality of multiplexers to control the plurality of storage elements.

15. The circuit of claim 10 wherein a total number of the plurality of the storage elements is equal to ((error correction code bytes+1)×a width of the input data bus)+((error correction code bytes+1)×2).

16. The circuit of claim 14 wherein the second input signal and the third input signal control the first output signal by controlling output signals of the plurality of multiplexers.

17. The circuit of claim 10 wherein an asserted second input signal and an asserted third input signal de-assert the first output signal.

18. The circuit of claim 17 wherein the de-asserted first output signal indicates a presence of an irrelevant byte on the output data bus.

19. A method comprising:
receiving bytes of a data packet;
transmitting only relevant bytes of the data packet while receiving the bytes of the data packet; and
identifying irrelevant bytes while receiving the bytes of the data packet.

20. The method of claim 19 wherein the receiving the bytes of the data packet is performed via an input bus.

21. The method of claim 19 wherein the transmitting the relevant bytes of the data packet comprises utilizing an output bus.

22. The method of claim 21 wherein the transmitting the relevant bytes of the data packet further comprises transmitting the relevant bytes to a data customer via an output bus.

23. The method of claim 22 wherein the transmitting the relevant bytes to the data customer comprises informing the data customer that the transmitted bytes are relevant.

24. The method of claim 23 wherein the informing the data customer is performed by asserting an output signal line.

25. The method of claim 19 wherein the transmitting the relevant bytes of the data packet is performed prior to receiving an end of the data packet indication.

26. The method of claim 19 wherein the irrelevant bytes are error correction code bytes.

27. The method of claim 19 wherein the identifying the irrelevant bytes is performed upon receiving an end of the data packet indication.

28. The method of claim 19 further comprises delaying the transmitting the relevant bytes by a predetermined number of bytes.

29. The method of claim 28 wherein the predetermined number of bytes equals to a one greater than a number of the irrelevant bytes.

30. The method of claim 29 wherein the delaying the transmitting the relevant bytes is performed by a circuit.

31. The method of claim 30 wherein the circuit comprises a plurality of storage elements.

32. The method of claim 31 wherein a total number of the plurality of the storage elements is equal to ((the number of irrelevant bytes+1)×a width of an input bus)+((the number of the irrelevant bytes+1)×2)).

33. An apparatus comprising:
means for receiving bytes of a data packet;
means for transmitting relevant bytes of the data packet while receiving the bytes of the data packet; and
means for identifying irrelevant bytes while receiving the bytes of the data packet.

34. The apparatus of claim 33 wherein the means for receiving the bytes of the data packet comprise means for receiving the bytes of the data packet via a bus.

35. The apparatus of claim 33 wherein the means for transmitting the relevant bytes of the data packet further comprise means for delaying the transmitting of the relevant bytes by a predetermined number of bytes.

36. The apparatus of claim 35 wherein the predetermined number of bytes equals to a one greater than a number of the irrelevant bytes.

37. The apparatus of claim 33 wherein the means for identifying the irrelevant bytes further comprise means for identifying the irrelevant bytes upon a receipt of an end of the data packet indication.

38. The apparatus of claim 37 wherein the means for transmitting the relevant bytes comprise means for informing a data customer that the transmitted bytes are relevant.

39. The apparatus of claim 38 wherein the means for informing the data customer comprise means for asserting an output signal line.
